(19) United States
(12) Patent Application Publication
(10) Pub. No.: US 2026/0210322 A1
(43) Pub. Date: Jul. 23, 2026

(54) TEMPERATURE-CONTROLLABLE GLOW PLUG ASSISTED COMPRESSION IGNITION METHANOL ENGINE AND CONTROL METHOD THEREOF

(71) Applicant: TAIYUAN UNIVERSITY OF TECHNOLOGY, Taiyuan (CN)

(72) Inventors: Jianjun ZHU, Taiyuan (CN); Zhixin LI, Taiyuan (CN); Xiangyang LIU, Taiyuan (CN)

(21) Appl. No.: 18/714,340

(22) PCT Filed: Jan. 22, 2024
(86) PCT No.: PCT/CN2024/073455

§ 371 Date: May 29, 2024

(30) Foreign Application Priority Data
Nov. 22, 2022 (CN) 202211464325.6

(51) Int. Cl. F02D 41/00; F02B 47/00; F02M 25/00; F02P 19/02

(52) U.S. Cl. CPC F02D 41/0025; F02B 47/00; F02D 41/0002; F02M 25/00; F02P 19/025; F02P 19/026; F02D 2200/0404; F02D 2200/101

(57) ABSTRACT

Disclosed are a temperature-controllable glow plug assisted compression ignition methanol engine and a control method thereof. The requirements of methanol combustion on temperature in different engine working conditions can be satisfied by using temperature-controllable glow plugs, methanol is directly injected into an engine combustion chamber by a fuel injector, and a methanol mixture can be stably and reliably ignited through temperature-controllable glow plugs in the combustion chamber. By controlling temperature of the glow plug and an excess air coefficient of the methanol mixture in a cylinder, the ignition and combustion of the engine in different working conditions can achieve the optimal effect. The coordinated control of the temperature of the glow plug and the excess air coefficient enables the stable combustion of the methanol engine and makes the compression ignition methanol engine achieve the best economy and power.

### CROSS-REFERENCE TO RELATED APPLICATION

This application is a U.S. national stage application of PCT International Patent Application No. PCT/CN2024/073455, filed on Jan. 22, 2024, which claims priority of the Chinese Patent Application No. 202211464325.6, filed on Nov. 22, 2022, both of which are incorporated by references in their entities.

### TECHNICAL FIELD

The present disclosure belongs to the technical field of vehicle engine control, and in particular to a temperature-controllable glow plug assisted compression ignition methanol engine and a control method thereof.

### BACKGROUND

Global warming is one of the most serious threats to the earth and human beings so far, and all walks of life are gradually reducing the use and reliance on fossil fuels. Methanol, as a new clean fuel, can replace gasoline and diesel, and is an important part of new energy. The original engine is slightly modified when the engine is fueled with methanol as an alternative fuel, and thus the economic performance of the original engine can be improved and carbon emissions can be reduced on the basis of satisfying the dynamic performance of the original engine.

The compression ignition engine has the advantages of low fuel consumption, high reliability, good altitude characteristics, low rotation speed, large torque, etc., but the characteristics of low calorific value, high latent heat of vaporization and high auto-ignition temperature of methanol make it difficult for methanol to be compression ignited. Therefore, the compression ignition methanol engine needs to solve the problem of unstable combustion.

At present, the measures taken to stabilize compression ignition of the methanol engine include intake gas heating, diesel ignition, glow plug assisted compression ignition. The glow plug assisted compression ignition mode can improve the cold start performance and solve the problem of difficult ignition of the methanol engine, but has the problems of short life, high energy consumption and unable to change temperature with working conditions, so further measures need to be taken to optimize such a combustion mode of the glow plug assisted compression ignition.

### SUMMARY

In order to solve the problems above, a temperature-controllable glow plug assisted compression ignition methanol engine and a control method thereof are provided.

The present disclosure employs the following technical solution: a temperature-controllable glow plug assisted compression ignition methanol engine, comprising an engine housing including a methanol engine water jacket, a methanol engine block, a methanol engine crankcase, and an oil pan. A top of the engine housing is provided with a methanol engine cylinder head, the engine housing is internally provided with a methanol engine crankshaft and methanol engine connecting rods driving the methanol engine crankshaft; methanol engine pistons are connected to upper ends of the methanol engine connecting rods, and cylinders are formed between the methanol engine cylinder head and the methanol engine pistons; the methanol engine cylinder head is provided with methanol engine exhaust manifolds, methanol injectors, temperature-controllable glow plugs and methanol engine intake manifolds; each of the methanol injectors and a corresponding one of the temperature-controllable glow plugs both extend into a corresponding one of the cylinders, and a throttle is arranged at an air intake of each of the methanol engine intake manifolds; a pipeline configured for communicating the throttle with external air is provided with an air flowmeter; the methanol injectors, the temperature-controllable glow plugs and the throttle are controlled by an electronic control unit (ECU) of the methanol engine; the electronic control unit (ECU) is configured to perform regulation of temperature of each of the temperature-controllable glow plugs and opening of the throttle according to a current load state of the methanol engine; and the load state takes mean effective pressure of the methanol engine calculated according to a rotation speed and effective power of the methanol engine at a moment as a determination index.

Each of the temperature-controllable glow plugs is provided with a glow plug temperature sensor configured to measure a surface temperature of the each of the temperature-controllable glow plugs and to feed back temperature information to the electronic control unit (ECU).

The throttle is internally provided with a throttle position sensor configured to monitor the opening of the throttle and feed back position information to the electronic control unit (ECU).

A control method of the temperature-controllable glow plug assisted compression ignition methanol engine includes following steps:
S1: when the methanol engine is started into an idle state, controlling, by the electronic control unit (ECU), the opening of the throttle to keep it within a range of 4° to 8°, wherein air input at the moment is small, an excess air coefficient is controlled and kept within a range of 0.8 to 1.0, and the temperature of the each of the temperature-controllable glow plugs is kept within a range of 1200° C. to 1300° C.;
S2: when the methanol engine is accelerated smoothly, adjusting, by the electronic control unit (ECU), the opening of the throttle according to fuel consumption changing in real time, feeding back change of air flow rate to the electronic control unit (ECU) by the air flowmeter, and further correcting the opening of the throttle, wherein the opening of the throttle is increased with increase of the fuel consumption, thus controlling the excess air coefficient to be within a range of 1.4 to 1.8, and keeping the temperature of the each of the temperature-controllable glow plugs within a range of 1250° C. to 1300° C.;

During the acceleration of the methanol engine, the flow rate and flow of air inhaled by the engine increase due to the increase of rotation speed and opening of the throttle. As the air input in the same opening time of the throttle per cycle increases, organized air swirl and intake tumble around the axis perpendicular to the cylinder can be formed faster with the increase of the air flow rate, the turbulence intensity at the end of compression is increased, and the formation of a methanol mixture is accelerated, thus making the flame front to wrinkle to increase the area of the flame front and accelerate heat transfer between burnt gas and unburnt gas, so as to improve the combustion rate, suppress knocking, reduce cycle variation, improve lean combustion ability, and improve the performance of the methanol engine;
S3: when the methanol engine is accelerated rapidly, controlling, by the electronic control unit (ECU), the throttle to be in wide open, so as to ensure that instantaneous air input meets a requirement of stable combustion of methanol, and the temperature of the each of the temperature-controllable glow plugs is kept within a range of 1275° C. to 1300° C.;
S4: when the methanol engine is decelerated smoothly, reducing, by the electronic control unit (ECU), fuel supply, and adjusting the opening of the throttle, feeding back the change of air flow rate to the electronic control unit (ECU) by the air flowmeter, and further correcting the opening of the throttle, wherein the opening of the throttle is reduced with decrease of the fuel consumption, thus controlling the excess air coefficient to be within a range of 1.2 to 1.4, and keeping the temperature of the each of the temperature-controllable glow plugs within a range of 950° C. to 1050° C.; and
S5: when the methanol engine is in emergency braking, cutting off the fuel supply by the ECU, wherein the opening of the throttle is adjusted to 2° to 5°, and the temperature of the each of the temperature-controllable glow plugs is kept within a range of 700° C. to 750° C.

A calculation process of the excess air coefficient is as follows: the electronic control unit (ECU) obtains the air input L (m³/h) at the moment according to information collected by the throttle position sensor and an air flow sensor, and calculates a theoretical air-fuel ratio l₀ equal to 0.65 and an actual air-fuel ratio l equal to 1.29×L/Q at the moment from total fuel consumption Q (kg/h), a theoretical air input L₀=l₀×Q/1.29, wherein the excess air coefficient λ is a ratio of the actual air-fuel ratio to the theoretical air-fuel ratio, that is, 2=1/l₀, and the excess air coefficient λ is also a ratio of the actual air input to the theoretical air input, that is, 2=L/L₀.

In S3, when the methanol engine is in following stable working condition after acceleration process is finished, controlling, by the electronic control unit (ECU), the opening of the throttle and the temperature of the each of the temperature-controllable glow plugs according to a set range of the stable working condition:
S31: when the mean effective pressure is 0.2 MPa to 0.4 MPa, enabling the methanol engine to be in a low load condition, controlling, by the electronic control unit (ECU), the opening of the throttle to keep the excess air coefficient λ within a range of 1.5≤λ≤1.8; obtaining, by the electronic control unit (ECU), the temperature of the each of the temperature-controllable glow plugs at the moment according to a signal of the glow plug temperature sensor, and controlling the temperature of the each of the temperature-controllable glow plugs to be within a range of 1150° C. to 1200° C.;
S32: when the mean effective pressure is 0.4 MPa to 0.7 MPa, enabling the methanol engine to be in a medium load condition, controlling, by the electronic control unit (ECU), the opening of the throttle to make the excess air coefficient λ within a range of 1.4≤λ≤1.7, obtaining, by the electronic control unit (ECU), the temperature of the each of the temperature-controllable glow plugs at the moment according to a signal of the glow plug temperature sensor, and controlling the temperature of the each of the temperature-controllable glow plugs to be within a range of 1050° C. to 1150° C.; and
S33: when the mean effective pressure is greater than or equal 0.7 MPa, enabling the methanol engine to be in a high load condition, controlling, by the electronic control unit (ECU), the opening of the throttle to make the excess air coefficient λ within a range of 1.2≤λ≤1.4, obtaining, by the electronic control unit (ECU), the temperature of the each of the temperature-controllable glow plugs according to a signal of the glow plug temperature sensor, and controlling the temperature of the each of the temperature-controllable glow plugs to be within a range of 1000° C. to 1050° C.

Formula of the mean effective pressure is

$${p}_{m e} = \frac{30 τ {P}_{e}}{{V}_{S} i n} ,$$

wherein pₘₑ is the mean effective pressure, τ is number of strokes, Pₑ is the effective power, Vₛ is single cylinder working volume, i is number of cylinders, and n is the rotation speed.
Compared with the Prior Art, the Present Disclosure has the Following Beneficial Effects:
1. The temperature-controllable glow plug can select an appropriate temperature thereof according to actual working conditions, the temperature-controllable glow plug with the high temperature is selected when the methanol engine is in a low load, and the temperature of the temperature-controllable glow plug is reduced when the methanol engine is in a high load, so as to reduce the energy consumption of the temperature-controllable glow plug to the maximum extent and prolong the service life of the glow plug on the basis of satisfying the full combustion of the methanol mixture;
2. Reasonable excess air coefficient is matched with the corresponding temperature of the glow plug. When the methanol engine is in the low load, high temperature of the glow plug and high excess air coefficient make the combustion more fully to improve thermal efficiency. When the methanol engine is in the large and medium load, appropriate increase of the mixture concentration can optimize the ignition performance of the methanol mixture to make the compression ignition easier, reduce cycle volatility, reduce fuel consumption and reduce the emissions of unburnt methanol, formaldehyde, formic acid and other harmful substances.

### BRIEF DESCRIPTION OF THE DRAWINGS

FIG. 1 is a schematic diagram of a temperature-controllable glow plug assisted compression ignition methanol engine according to the present disclosure;

FIG. 2 is a layout schematic diagram of a glow plug and a fuel injector of a temperature-controllable glow plug assisted compression ignition methanol engine according to the present disclosure;

FIG. 3 shows a curve graph of a change of in-cylinder pressure with the opening of the throttle opening in a low load working condition;

FIG. 4 shows a curve graph of a change of a heat release rate with the opening of the throttle in a low load working condition; and

FIG. 5 shows a curve graph of a change of cycle volatility with the opening of the throttle in a low load working condition.

In the drawings: 1—methanol engine crankshaft; 2—methanol engine connecting rod; 3—methanol engine piston; 4—methanol engine exhaust manifold; 5—methanol engine cylinder head; 6—methanol injector; 7—temperature-controllable glow plug; 8—engine engine intake manifold; 9—electronically controlled throttle; 10—electronic control unit; 11—methanol engine water jacket; 12—methanol engine block; 13—methanol engine crankcase; 14—oil pan; 15—output flange; and 16—air flowmeter.

### DETAILED DESCRIPTION OF THE EMBODIMENTS

To make the objectives, technical solutions and advantages of the present disclosure more clearly, the following clearly and completely describes the technical solutions in the embodiments of the present disclosure with reference to the accompanying drawings in the embodiments of the present disclosure. Apparently, the accompanying drawings in the following description show merely a part rather than all of the embodiments of the present disclosure, and those of ordinary skill in the art may still derive other drawings from these accompanying drawings without creative efforts.

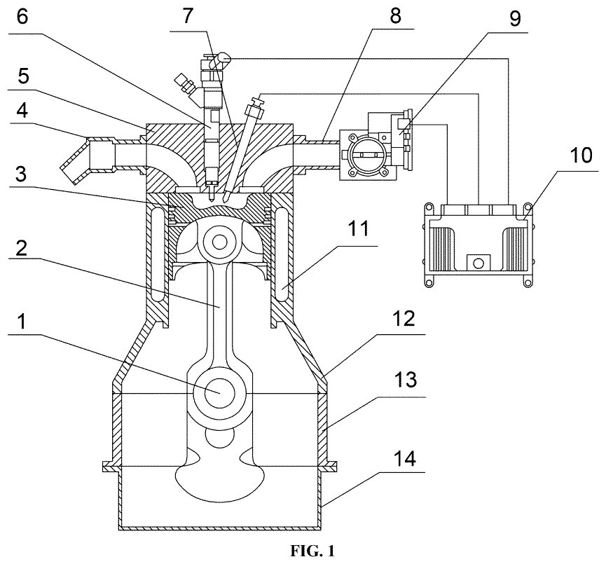

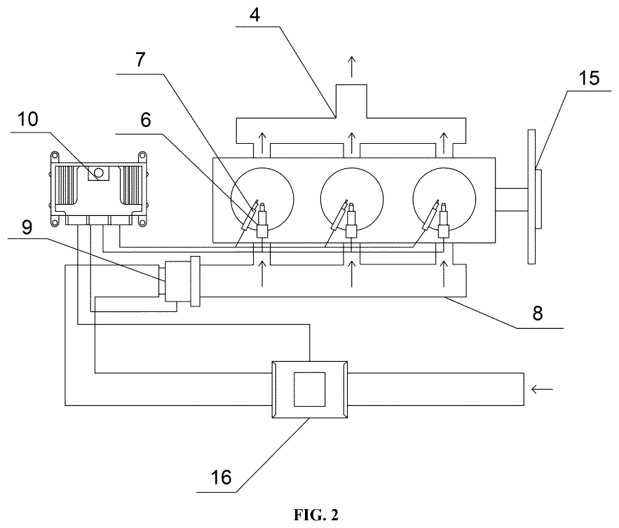

As shown in FIG. 1 and FIG. 2, a temperature-controllable glow plug assisted compression ignition methanol engine includes an engine housing including a methanol engine water jacket 11, a methanol engine block 12, a methanol engine crankcase 13, and an oil pan 14. A top of the engine housing is provided with a methanol engine cylinder head 5, and the engine housing is internally provided with a methanol engine crankshaft 1 and methanol engine connecting rods 2. The methanol engine connecting rods 2 drives the methanol engine crankshaft 1. Methanol engine pistons 3 are connected to upper ends of the methanol engine connecting rods 2, and cylinders are formed between the methanol engine cylinder head 5 and the methanol engine pistons 3. The methanol engine cylinder head 5 is provided with methanol engine exhaust manifolds 4, methanol injectors 6, temperature-controllable glow plugs 7 and methanol engine intake manifolds 8. The methanol injector 6 and the temperature-controllable glow plug 7 both extend into the cylinder, and a throttle 9 is arranged at an air intake of the methanol engine intake manifold 8. A pipeline for communicating the throttle 9 with external air is provided with an air flowmeter 16. The methanol injectors 6, the temperature-controllable glow plugs 7 and the throttles 9 are controlled by an electronic control unit (ECU) of the methanol engine. The electronic control unit (ECU) is configured to perform temperature regulation and throttle opening change according to a current load state of the methanol engine. The load state takes mean effective pressure of the engine calculated according to a current engine speed and current effective power of the engine as a determination index.

The temperature-controllable glow plug 7 is provided with a glow plug temperature sensor configured to measure a surface temperature of the temperature-controllable glow plug and feed back temperature information to the electronic control unit (ECU). A throttle position sensor is arranged in the throttle 9, and is configured to monitor the opening of the throttle and feed back position information to the electronic control unit (ECU). The fuel injection quantity of the methanol injector is obtained by controlling power-on time of the methanol injector by the ECU, and the ECU can calculate the actual fuel injection quantity according to the power-on time, and the sum of the fuel injection quantity of each fuel injector is the total fuel consumption.

A control strategy of the glow plug assisted compression ignition methanol engine is to optimize the combustion of methanol mixture by controlling the opening of the throttle to change the air input and controlling the temperature of the glow plug. Excessively rich methanol mixture may cause incomplete methanol combustion, leading to the increase of the emissions of harmful substances such as soot, Co and NOx. Excessively lean methanol mixture may cause the reduction of the combustion speed of the fuel, and less heat released by the combustion of this part of gas mixture becomes mechanical power, leading to the decrease of an output torque. Appropriate methanol mixture concentration can greatly improve the engine performance, and the selection of the temperature of the glow plug can reduce the energy consumption while the glow plug optimizes the ignition performance of the methanol mixture.

Formula of mean effective pressure is

$${p}_{m e} = \frac{30 τ {P}_{e}}{{V}_{S} i n} ,$$

in the formula, Pₘₑ is the mean effective pressure, τ is the number of strokes, Pₑ is effective power, Vₛ is single cylinder working volume, i is the number of cylinders, and n is the rotation speed. The mean effective pressure of the engine can be calculated according to the engine speed and the effective power at the moment, and the mean effective pressure can be used as an important index for determining a load state of the engine.

A control method of a temperature-controllable glow plug assisted compression ignition methanol engine includes the following steps:

In step 1, when an engine is started into an idle state, an electronic control unit (ECU) controls each of the throttles 9 to keep the opening of the throttle 9 within the range of 4° to 8°, where the air input at the moment is small, an excess air coefficient is controlled and kept within the range of 0.8 to 1.0, and a temperature of a temperature-controllable glow plug 7 is kept within the range of 1200° C. to 1300° C., so as to ensure that the injected methanol can be rapidly compression-ignited, and the engine can be rapidly started.

In step 2, when the engine is accelerated smoothly, the electronic control unit (ECU) controls the excess air coefficient to be within the range of 1.4 to 1.8 by adjusting the opening of the throttle according to the fuel consumption changing in real time and the actual air flow. The ECU calculates the excess air coefficient λ changing in real time according to the fuel consumption and the actual air flow which is fed back by the air flowmeter to the electronic control unit (ECU). When λ≤1.4, the ECU drives a motor to increase the opening of the throttle, and when λ≥1.8, the opening of the throttle is reduced, thus the opening of the throttle is corrected continuously to increase the appropriate opening of the throttle with the increase of the fuel consumption, and the temperature of the glow plug is kept within the range of 1250° C. to 1300° C.

During the acceleration of the engine, the flow rate and flow of air inhaled by the engine increase due to the increase of rotation speed and opening of the throttle. As the air input in the same opening time of the throttle per cycle increases, organized air swirl and intake tumble around the axis perpendicular to the cylinder can be formed faster with the increase of the air flow rate, the turbulence intensity at the end of compression is increased, and the formation of a methanol mixture is accelerated, thus making the flame front to wrinkle to increase the area of the flame front and accelerate heat transfer between burnt gas and unburnt gas, so as to improve the combustion rate, suppress knocking, reduce cycle variation, improve lean combustion ability, and improve the performance of the methanol engine.

In step 3, when the engine is accelerated rapidly, the electronic control unit (ECU) controls the throttle 9 to be in wide open, so as to ensure that instantaneous air input meets a requirement of stable combustion of methanol, and the temperature of the glow plug is kept within the range of 1275° C. to 1300° C. When the engine is in the following stable working condition after the acceleration process is finished, the electronic control unit (ECU) controls the opening of the throttle and the temperature of the glow plug according to a set range of the stable working condition.

In step 31, when the mean effective pressure is 0.2 MPa to 0.4 MPa, the engine is in a low load condition, the opening of the throttle 9 is controlled by the electronic control unit (ECU) to keep the excess air coefficient λ within the range of 1.5≤λ≤1.8. The electronic control unit (ECU) obtains the temperature of the temperature-controllable glow plug 7 at the moment according to a signal of the glow plug temperature sensor, and controls the temperature of the temperature-controllable glow plug 7 to be within the range of 1150° C. to 1200° C. Therefore, in the low load condition, the combustion of the methanol mixture achieves the optimal effect, and at the moment, the output power of the engine is increased, and the mean effective pressure is increased within the current range.

In step 32, when the mean effective pressure is 0.4 MPa to 0.7 MPa, the engine is in a medium load condition, the opening of the throttle 9 is controlled by the electronic control unit (ECU) to make the excess air coefficient λ within the range of 1.4≤λ≤1.7. The electronic control unit (ECU) obtains the temperature of the temperature-controllable glow plug 7 at the moment according to a signal of the glow plug temperature sensor, and controls the temperature of the temperature-controllable glow plug 7 to be within the range of 1050° C. to 1150° C. Therefore, in the medium load condition, the combustion of the methanol mixture achieves the optimal effect, and at the moment, the output power of the engine is increased, and the mean effective pressure is increased within the current range.

In step 33, when the mean effective pressure is greater than or equal 0.7 MPa, the engine is in a high load condition, the opening of the throttle 9 is controlled by the electronic control unit (ECU) to make the excess air coefficient λ within the range of 1.252≤1.4. The electronic control unit (ECU) obtains the temperature of the temperature-controllable glow plug 7 at the moment according to a signal of the glow plug temperature sensor, and controls the temperature of the temperature-controllable glow plug 7 to be within the range of 1000° C. to 1050° C. Therefore, in the high load condition, the combustion of the methanol mixture achieves the optimal effect, and at the moment, the output power of the engine is increased, and the mean effective pressure is increased within the current range.

In step 4, when the engine is decelerated smoothly, the electronic control unit (ECU) reduces fuel supply, and adjusts the opening of the throttle 9, so as to control the excess air coefficient to be within the range of 1.2 to 1.4. The ECU calculates the excess air coefficient 2 changing in real time according to the fuel consumption and the actual air flow which is fed back by the air flowmeter to the electronic control unit (ECU). When λ≤1.2, the ECU drives a motor to increase the opening of the throttle, and when 221.4, the opening of the throttle is reduced thus the opening of the throttle is corrected continuously to decrease the appropriate opening of the throttle with the decrease of the fuel consumption, and the temperature of the glow plug is kept within the range of 950° C. to 1050° C.

In step 5, when the engine is in emergency braking, the ECU cuts off the fuel supply, and at the moment, the opening of the throttle 9 is adjusted to 2° to 5°, and the temperature of the glow plug is kept within the range of 700° C. to 750° C.

Various parameters in the above control process are not conventional choices, but optimal choices obtained through experiments. During the experiment, only the opening of the throttle or the temperature of the glow plug is changed in the same working condition, and the data such as output torque, effective output power, fuel consumption, in-cylinder pressure, cycle volatility and emission are obtained by means of a dynamometer, a fuel consumption meter, a combustion analyzer and an emission meter. The optimal opening range of the throttle, the range of excess air coefficient and the optimal temperature range of glow plug which correspond to the opening of the throttle are selected according to the experimental data. The following is an example of the low load condition.

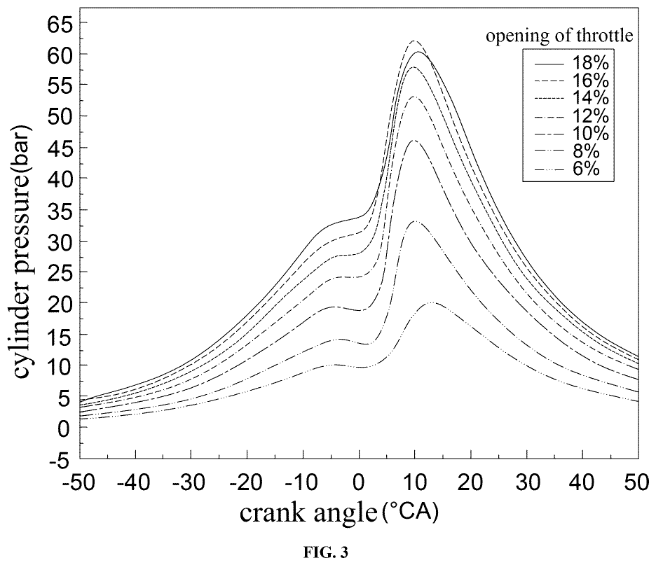

FIG. 3 shows a curve graph of in-cylinder pressure at the opening of the throttle of 6% to 18% in a low load condition of an engine of 1200 r/min. As can be seen from the figure, with the increase of the opening of the throttle, the curve of the in-cylinder pressure is in an upward trend as a whole, and the maximum pressure gradually increases. However, when the opening of the throttle is 18%, a crank angle is 10.4° C. A, and the maximum in-cylinder pressure is 60.42 bar, and when the opening of the throttle is 16%, the crank angle is 9.5° C. A, the maximum in-cylinder pressure is 62.02 bar, and the maximum cylinder pressure is reduced by 3%. It can be obtained that the continuous increase of the opening of the throttle will cause the in-cylinder pressure continually drop, so than the optimal opening of the throttle is controlled within 16%. When the opening of the throttle is 16%, the measured fuel consumption is 2.73 kg/h, the measured air flow rate is 25.18 m³/h, and the correspondingly calculated excess air coefficient λ is 1.8305.

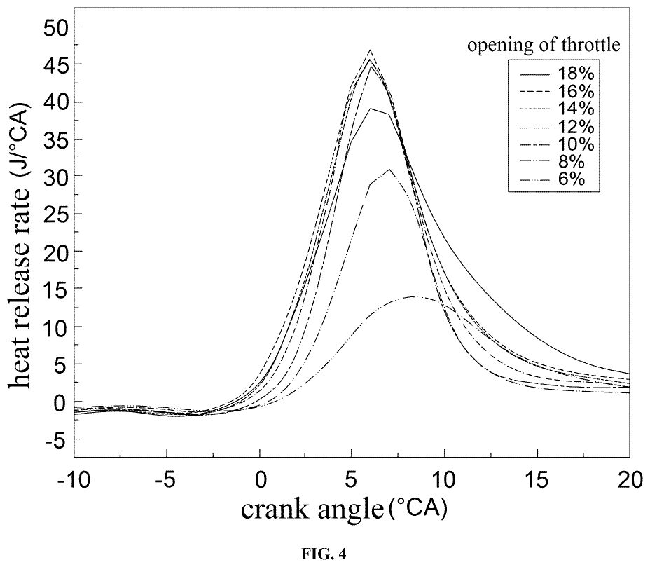

FIG. 4 shows a curve graph of a heat release rate at the opening of the throttle of 6% to 18% in a low load condition of an engine of 1200 r/min. As can be seen from the figure, with the increase of the opening of the throttle, the curve of the heat release rate is in an upward trend as a whole. When the opening of the throttle is 12%, the crank angle is 6° C. A, a peak heat release rate is up to 46.88, and when the opening of the throttle is 16% or 18%, the peak heat release rate decreases. It can be obtained that the heat release rate is high when the opening of the throttle is within the range of 12% to 16%, and decreases too much when the opening of the throttle is greater than 16%, thus the opening of the throttle should be controlled within the range of 12% to 16%. When the opening of the throttle is 12%, the measured fuel consumption is 2.58 kg/h, the measured air flow rate is 19.28 m³/h, and the corresponding excess air coefficient λ at the moment is 1.4831≤λ≤1.8305.

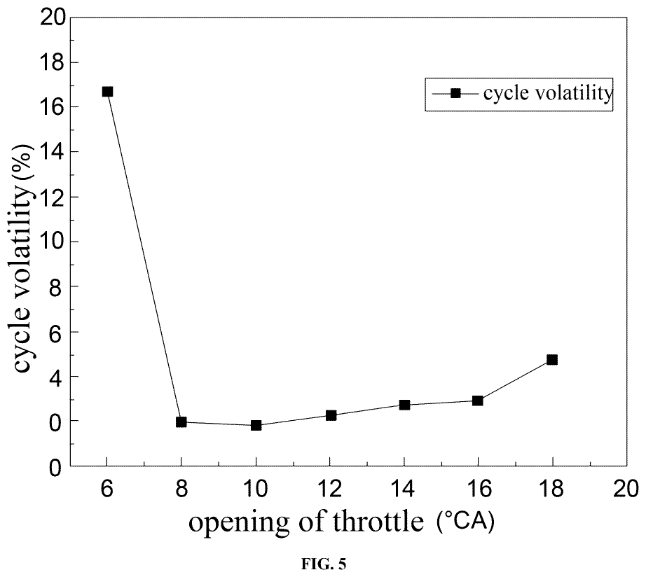

FIG. 5 shows a curve graph of cycle volatility at the opening of the throttle of 6% to 18% in a low load condition of an engine of 1200 r/min. As can be seen from the figure, with the increase of the opening of the throttle, the cycle volatility gradually increases, and the large cycle volatility will cause the gradual increase of the number of cycles with abnormal combustion or even fire off, so that the incomplete combustion products such as hydrocarbons is increased, and the power economy is decreased. Meanwhile, the unstable combustion process also increases the vibration noise, resulting in the reduction of the service life of parts of the engine. Therefore, it is proved that the opening of the throttle cannot be increased continuously, and the opening of the throttle should be controlled within the optimal range.

It can be concluded from the experimental data that the engine has the best operation state when the opening of the throttle is within the range of 12% to 16% in the current low load condition. The air flow rate and fuel consumption when the opening of the throttle is within the range of 12% to 16% are obtained by means of experiments, and the optimal range of excess air coefficient at the moment can be calculated to be about 1.5 to 1.8. Experiments show that the optimal range of excess air coefficient of the engine is also 1.5 to 1.8 in low load conditions with different rotation speeds.

Specifically, the selection of the above parameters is similar to the above steps. The optimal range of the excess air coefficient and temperature of the glow plug is measured on a test bench and written into the ECU. On a real vehicle, the ECU controls the opening of the throttle and temperature of the glow plug, and makes the excess air coefficient and temperature of the glow plug stable in the optimal range according to different working conditions.

Specifically, the control of the range of the excess air coefficient is that the ECU obtains the air input L(m³/h) according to information of a throttle position sensor and an airflow sensor, and then calculates a theoretical air-fuel ratio l and an actual air-fuel ratio l₀ from the total fuel consumption Q (kg/h). The excess air coefficient is a ratio of the actual air-fuel ratio to the theoretical air-fuel ratio, the theoretical air-fuel ratio of the methanol is 6.5, the actual air-fuel ratio of the methanol is 1.29×L/Q, and the excess air coefficient λ is 1/l₀. The air input and the total fuel consumption are controlled to achieve the purpose of controlling the excess air coefficient.

Specifically, the temperature-controllable glow plug is made of ceramic, the input voltage ranges from 20 V to 28 V, and the controllable temperature ranges from 750° C. to 1300° C. The temperature can be fed back to the ECU in time, the controller keeps the temperature in the range all the time, and the methanol mixture burns stably in the cylinder, which improves the economy and power of the engine.

The structure, the scale, the size and the like shown in the drawings attached in this specification are all simply used to match with the content disclosed by the specification for those skilled in the art understanding and reading, rather than limiting restrictive conditions capable of implemented by the present disclosure. Therefore, any modification of structure, alteration of proportional relation, or modulation of size without technical essential meanings shall be fall into the covered scope by the disclosed technical solution of the present disclosure without affecting the generated function and achieved objects of the present disclosure. Meanwhile, terms such as “up”, “down”, “left”, “right”, “middle”, “one” and the like cited in this specification are also simply for clearness of the description, rather than limiting the scope capable of being implemented by the present disclosure. The change or the adjustment of the relative relation should also be seen as the scope of the present disclosure when there is no substantial alteration in the technical content.

Finally, it should be noted that the above embodiments are only used to illustrate the technical solution of the present disclosure rather than limiting. Although the present disclosure has been described in detail with reference to the foregoing embodiments, those of ordinary skill in the art should understand that it is still possible to modify the technical solution described in the previous embodiments, or replace some or all of the technical features equally. However, these modifications or substitutions do not make the essence of the corresponding technical solutions deviate from the spirit and scope of the technical solutions of various embodiments of the present disclosure.

1. A temperature-controllable glow plug assisted compression ignition methanol engine, comprising:
an engine housing including a methanol engine water jacket,
a methanol engine block,
a methanol engine crankcase,
an oil pan,
wherein a top of the engine housing is provided with a methanol engine cylinder head, the engine housing is internally provided with a methanol engine crankshaft and methanol engine connecting rods driving the methanol engine crankshaft; methanol engine pistons are connected to upper ends of the methanol engine connecting rods, and cylinders are formed between the methanol engine cylinder head and the methanol engine pistons; the methanol engine cylinder head is provided with methanol engine exhaust manifolds, methanol injectors, temperature-controllable glow plugs and methanol engine intake manifolds; each of the methanol injectors and a corresponding one of the temperature-controllable glow plugs both extend into a corresponding one of the cylinders, and a throttle is arranged at an air intake of each of the methanol engine intake manifolds; and
a pipeline configured for communicating the throttle with external air is provided with an air flowmeter; the methanol injectors, the temperature-controllable glow plugs and the throttle are controlled by an electronic control unit of the methanol engine; the electronic control unit is configured to perform regulation of temperature of each of the temperature-controllable glow plugs and opening of the throttle according to a current load state of the methanol engine; and the load state takes mean effective pressure of the methanol engine calculated according to a rotation speed and effective power of the methanol engine at a moment as a determination index.

2. The temperature-controllable glow plug assisted compression ignition methanol engine according to claim 1, wherein each of the temperature-controllable glow plugs is provided with a glow plug temperature sensor configured to measure a surface temperature of the each of the temperature-controllable glow plugs and to feed back temperature information to the electronic control unit.

3. The temperature-controllable glow plug assisted compression ignition methanol engine according to claim 2, wherein the throttle is internally provided with a throttle position sensor configured to monitor the opening of the throttle and feed back position information to the electronic control unit.

4. A control method of the temperature-controllable glow plug assisted compression ignition methanol engine according to claim 3, comprising following steps:
S1: when the methanol engine is started into an idle state, controlling, by the electronic control unit, the opening of the throttle to keep it within a range of 4° to 8°, wherein air input at the moment is small, an excess air coefficient is controlled and kept within a range of 0.8 to 1.0, and the temperature of the each of the temperature-controllable glow plugs is kept within a range of 1200° C. to 1300° C.;
S2: when the methanol engine is accelerated smoothly, adjusting, by the electronic control unit, the opening of the throttle according to fuel consumption changing in real time, feeding back change of air flow rate to the electronic control unit by the air flowmeter, and further correcting the opening of the throttle, wherein the opening of the throttle is increased with increase of the fuel consumption, thus controlling the excess air coefficient to be within a range of 1.4 to 1.8, and keeping the temperature of the each of the temperature-controllable glow plugs within a range of 1250° C. to 1300° C.;
S3: when the methanol engine is accelerated rapidly, controlling, by the electronic control unit, the throttle to be in wide open, so as to ensure that instantaneous air input meets a requirement of stable combustion of methanol, and the temperature of the each of the temperature-controllable glow plugs is kept within a range of 1275° C. to 1300° C.;
S4: when the methanol engine is decelerated smoothly, reducing, by the electronic control unit, fuel supply, and adjusting the opening of the throttle, feeding back the change of air flow rate to the electronic control unit by the air flowmeter, and further correcting the opening of the throttle, wherein the opening of the throttle is reduced with decrease of the fuel consumption, thus controlling the excess air coefficient to be within a range of 1.2 to 1.4, and keeping the temperature of the each of the temperature-controllable glow plugs within a range of 950° C. to 1050° C.; and
S5: when the methanol engine is in emergency braking, cutting off the fuel supply by the ECU, wherein the opening of the throttle is adjusted to 2° to 5°, and the temperature of the each of the temperature-controllable glow plugs is kept within a range of 700° C. to 750° C.

5. The control method of the temperature-controllable glow plug assisted compression ignition methanol engine according to claim 4, wherein a calculation process of the excess air coefficient is as follows: the electronic control unit obtains the air input L at the moment according to information collected by the throttle position sensor and an air flow sensor, and then calculates a theoretical air-fuel ratio l₀ and an actual air-fuel ratio l equal to 1.29×L/Q at the moment from total fuel consumption Q, wherein the excess air coefficient λ is a ratio of the actual air-fuel ratio to the theoretical air-fuel ratio, that is, λ=l/l₀.

6. The control method of the temperature-controllable glow plug assisted compression ignition methanol engine according to claim 5, wherein in S3, when the methanol engine is in following stable working condition after acceleration process is finished, controlling, by the electronic control unit, the opening of the throttle and the temperature of the each of the temperature-controllable glow plugs according to a set range of the stable working condition:
S31: when the mean effective pressure is 0.2 MPa to 0.4 MPa, enabling the methanol engine to be in a low load condition, controlling, by the electronic control unit, the opening of the throttle to keep the excess air coefficient λ within a range of 1.5≤λ≤1.8;
obtaining, by the electronic control unit, the temperature of the each of the temperature-controllable glow plugs at the moment according to a signal of the glow plug temperature sensor, and controlling the temperature of the each of the temperature-controllable glow plugs to be within a range of 1150° C. to 1200° C.;
S32: when the mean effective pressure is 0.4 MPa to 0.7 MPa, enabling the methanol engine to be in a medium load condition, controlling, by the electronic control unit, the opening of the throttle to make the excess air coefficient λ within a range of 1.4≤λ≤1.7, obtaining, by the electronic control unit, the temperature of the each of the temperature-controllable glow plugs at the moment according to a signal of the glow plug temperature sensor, and controlling the temperature of the each of the temperature-controllable glow plugs to be within a range of 1050° C. to 1150° C.; and
S33: when the mean effective pressure is greater than or equal 0.7 MPa, enabling the methanol engine to be in a high load condition, controlling, by the electronic control unit, the opening of the throttle to make the excess air coefficient λ within a range of 1.2≤λ≤1.4, obtaining, by the electronic control unit, the temperature of the each of the temperature-controllable glow plugs according to a signal of the glow plug temperature sensor, and controlling the temperature of the each of the temperature-controllable glow plugs to be within a range of 1000° C. to 1050° C.

7. The control method of the temperature-controllable glow plug assisted compression ignition methanol engine according to claim 6, wherein formula of the mean effective pressure is
$${p}_{m e} = \frac{30 τ {P}_{e}}{{V}_{S} i n} ,$$
wherein pₘₑ is the mean effective pressure, τ is number of strokes, Pₑ is the effective power, Vₛ is single cylinder working volume, i is number of cylinders, and n is the rotation speed.
